(19) United States
(12) Patent Application Publication
(10) Pub. No.: US 2025/0325949 A1
(43) Pub. Date: Oct. 23, 2025

(54) System, Method, and Device for the Continuous Processing of Granular Materials Under an Atmosphere

(71) Applicants: Daniel Deocampo, Avondale Estates, GA (US); Richard Jensen, Atlanta, GA (US)

(72) Inventors: Daniel Deocampo, Avondale Estates, GA (US); Richard Jensen, Atlanta, GA (US)

(73) Assignee: Nalari Scientific, LLC, Atlanta, GA (US)

(21) Appl. No.: 18/639,924

(22) Filed: Apr. 18, 2024

(51) Int. Cl. B01J 3/02; B01J 3/04; B01J 8/00; B07B 1/04

(52) U.S. Cl. CPC B01J 3/02; B01J 3/042; B01J 8/002; B07B 1/04; B01J 2208/00752; B01J 2208/065

(57) ABSTRACT

The invention disclosed herein relates to a device and method for the processing of granular material continuously under a sealed atmosphere, being a novel improvement over batch processing and discontinuous granular processing. Specific embodiments are presented relating to extraction of volatile compounds from planetary bodies and the carbonation of recycled concrete.

### CROSS-REFERENCE TO RELATED APPLICATIONS

This application claims the benefit of priority to U.S. Provisional Application No. 63/460,282 filed Apr. 18, 2023, which is incorporated herein by reference.

### FIELD

The field of the invention relates to granular material processing. Specific embodiments relate to recycled concrete processing and mining of volatiles from planetary bodies.

### BACKGROUND

The present disclosure relates to a system, method, and device for the continuous processing of granular material under pressurized conditions substantially different from the ambient atmospheric pressure conditions, in order to conduct or control chemical reactions, reactants, or products thereof. Such conditions of atmospheric isolation are required for many industrial and environmental applications where chemical reactions between solid granular materials, liquids, and/or gasses are desired. Examples of such desirable chemical reactions are numerous, and may involve the chemical transformations of any of the phases involved. The desirable chemical reactions may involve the incorporation of material from the liquids and/or gas phases into the solid phases, or the exclusion of material from the solid phases and transfer into the liquid and/or gas phases. Or it may involve no net change in the solid phase, while liquid and/or gas phases react in the presence of the solid.

One example of a desirable reaction in which matter in the gas phase is incorporated into the solid phase is the carbonation of recycled concrete aggregate. In this chemical process, gaseous and aqueous carbon dioxide is combined with reactive calcium contained in recycled concrete aggregate, to produce calcium carbonate, among other simultaneous and subsequent chemical reactions. Other alkaline earth metals (Be, Mg, Ca, Sr, Ra, and Ba) chemically behave in the same manner, although calcium is the most abundant. The resulting aggregate has lower porosity, exhibits lower water absorption, greater workability for concrete production, and produces concrete with higher mechanical strength. In addition, it sequesters carbon dioxide and contains it permanently in a solid phase, thus reducing greenhouse gas emissions. Carbonation of concrete occurs in the ambient environment, but very slowly—the reaction is accelerated within a pressurized reaction chamber by elevating the partial pressure of carbon dioxide above the ambient levels. The process of carbonation of recycled concrete aggregate has been demonstrated in laboratory settings, and industrial demonstrations (Torrenti et al., 2022). The existing technologies for carrying it out, however, rely on batch treatment of the granular material, with devices such as airlocks, valves, and seals. These do not allow the continuous processing of aggregate, thus limiting the efficiency of the process. The innovation disclosed herein therefore provides greater processing capacity than existing approaches.

Another example of a desirable reaction in a pressurized environment involving granular material, liquids, and/or gasses, is the extraction of ice from lunar regolith. This process is important in the economic development of cis-lunar space, as water is an important raw material for generating propellant and life support beyond the Earth. During extraction of ice from lunar regolith, ice is warmed to the point of sublimation and removed from the regolith as a gas phase. Laboratory experiments and computer simulations have been carried out showing the potential for successful ice extraction from lunar regolith. Many of these rely on in situ sublimation of ice within the lunar surface, and capture of escaping water vapors-a process that is impractical because of the low thermal conductivity and low vapor permeability of lunar regolith. Other regolith processing technologies include lock hoppers and valves that provide batch operation and do not provide continuous feed of granular material into and out of the pressurized process chamber.

Current technologies for processing granular materials rely on valve or lock systems that do not allow continuous flow of granular material, or that allow reaction products to escape, or that allow excessive ambient gasses to enter the system, or that are subject to seal breakage by particles, or that are subject to abrasive damage. The innovation disclosed herein provides an improvement on these existing approaches by providing a means for substantially continuous processing of granular materials, while minimizing inadvertent loss of atmosphere or contamination of the reaction chamber.

In continuous processing of granular material into and out of a reaction chamber, the movement of gas in or out of the reaction chamber is prevented by diffusive, frictional, and viscous resistance to flow of gas through the granular material. Gas flows through pore spaces in granular materials by diffusion or by advective or viscous flow. Provided granular materials of sufficiently low porosity, low permeability, high tortuosity, high roughness, and high flowpath length or thickness, flow of gas is substantially negligible. In some cases, the parameters required for substantially negligible gas flow occur naturally within the granular materials. In other cases, the parameters can be adjusted by the addition of very fine grained material, such as particles less than 62.5 μm, less than 4 μm, less than 2 μm, or a subset of size fractions thereof. Gas flow parameters can further be adjusted by compression or dilation of granular materials, such as accomplished through the use of variable-flight augers in the movement of granular materials.

### SUMMARY

The present invention serves as a novel improvement in the field of granular material processing. The main object of the invention is to allow for continuous processing of a granular material under a contained atmosphere. The atmosphere contained within the processing chamber may vary in pressure, temperature, partial pressure, composition, humidity, and other similar variables as determined by specific processing needs. In all of the embodiments presented herein, the processing chamber processes a continuous throughput of granular material while maintaining this sealed atmosphere due to the novel valves disclosed, which use and manipulate the inherent gaseous impermeability of packed fine-grained materials.

The embodiments claimed are for a device to continuously process granular material under an atmosphere in a way that alters one or more thermodynamic, chemical or physical properties of the material. In all of the embodiments, the granular material is deposited into the processing chamber by a means for substantially continuous inflow of granular material, and is removed from said chamber after processing by means for substantially continuous outflow. It is through the means for the substantially continuous inflow and outflow that a substantially sealed atmosphere is created within chamber.

Most embodiments will use a hopper as the container for holding the granular material prior to moving it into the chamber. This hopper also helps create an overburden for containing the sealed environment within the chamber.

While there are many different options for the means for substantially continuous inflow presented in this disclosure, the preferred embodiments involve the use of an auger enclosed within a cylinder to convey the granular material from the hopper to the processing chamber.

Once processed, the granular material exists in the processing chamber in much the same way as it entered. The internal geometry of the chamber forms a hopper for holding the exiting material, which is then removed from the chamber at the bottom of the hopper by a means for substantially continuous outflow, being virtually the same as the means for substantially continuous inflow. Once again, the preferred embodiments use an auger enclosed within a cylinder for this purpose.

Furthermore, the augers used in this invention may have varied pitch angles and flight spacings to compact the granular material within the auger enclosure to create a seal or plug preventing the escape of the atmosphere contained within the processing chamber.

Another novel improvement presented in this disclosure is for recirculation of a fine-grained portion of the granular material to ensure that the inflowing granular material always has a grain size distribution that is optimized for creating a sealed environment within the chamber. After moving through the chamber, the fine-grained particles are sieved out of the exiting material and recirculated back to the means for substantially continuous inflow. In some embodiments where there is no sufficiently fine-grained portion, this invention allows for the introduction and recirculation of inert fine-grained particles specifically for creating a sealed system.

Finally, two specific embodiments are presented herein. The first is for using the device to obtain volatile compounds from a planetary body, such as the moon, mars or an asteroid. This involves providing the processing chamber with excavated regolith containing volatile compounds and then heating that regolith to release the compounds and capture them for storage and later use. The second specific embodiment is for the carbonation of recycled concrete particles to use as a carbon dioxide sink and strengthen the particles for use as aggregate in new concrete construction. This embodiment involves providing the processing chamber with a carbon dioxide atmosphere and ensuring that the concrete particles move evenly through the processing chamber with sufficient residence time to carbonate.

### DESCRIPTION OF THE DRAWINGS

FIG. 1 is a view of an embodiment of the invention with inflow hopper 10, means for substantially continuous conveyance 20 of granular material into the processing chamber 30, an internal hopper 40, and means of substantially continuous conveyance 50 of granular material out of the reaction process chamber.

FIG. 2 is a view of an embodiment of the invention in which the means of substantially continuous conveyance of granular material into the processing chamber is a screw auger 60, as the means of substantially continuous conveyance 50 of granular material out of the processing chamber.

FIG. 3 is a view of a screw auger means of substantially continuous conveyance of granular material with a region 70 with closely spaced auger flights, and regions 80 with more distantly spaced auger flights, so as to produce compression of the granular material in the region with closely spaced auger flights.

FIG. 4 is a view of an embodiment of the invention in which granular material conveyed out of the reaction processing chamber is passed through a sieve 90, with the fine fraction of granular material conveyed back to the inflow hopper by a means of conveyance 100 to effect recycling of the fine fraction, whereas the material coarser than the sieve size is collected in a container 110.

FIG. 5 is a view of an embodiment of the invention in which water vapor is extracted from icy lunar regolith by sublimation induced by microwave heating. Granular material is moved on the conveyor belt 140, sculpted by the comb or hood 120, radiation is emitted by the microwave emitters 130 and reflected by the radiation reflectors 150. Volatiles are removed from the processing chamber through a gas valve 160, and transmitted via conduit 170 to a volatile recovery unit 210.

FIG. 6 is a view of an embodiment of the invention in which crushed recycled concrete aggregate is carbonated by pressurized carbon dioxide. Carbon dioxide, water vapor, and other gasses as desired are conveyed into the processing chamber through a gas valve 190, being fed by a supply of gasses 200.

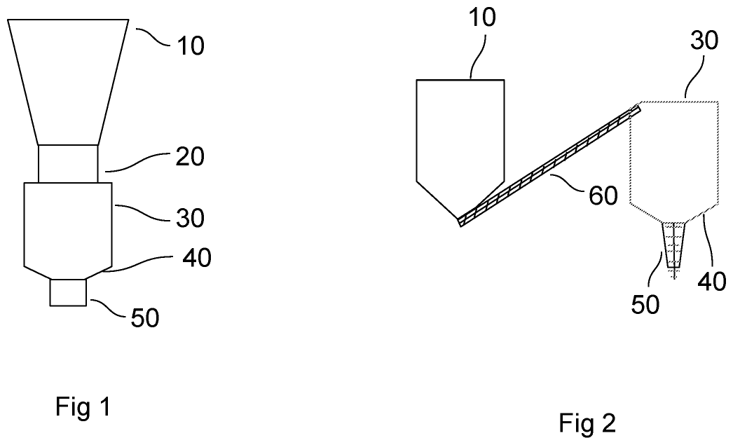

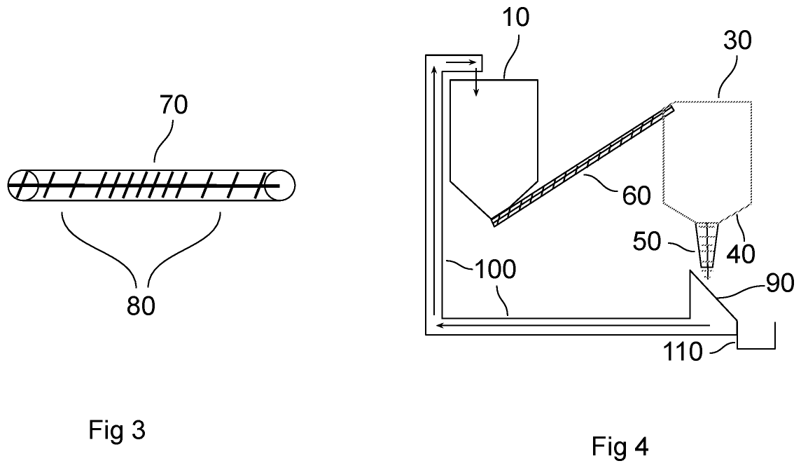

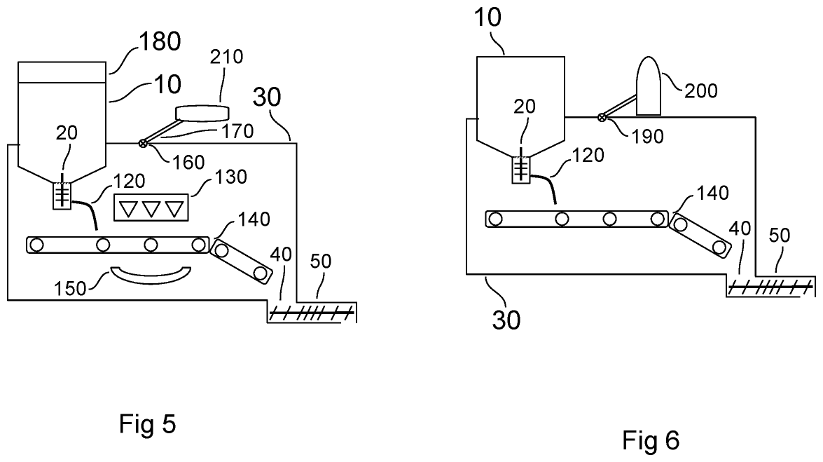

### DETAILED DESCRIPTION

The invention disclosed herein refers primarily to a device and method for the continuous processing of a granular material under a contained atmosphere. The various embodiments have three primary components: a processing chamber 30 in which the granular material is processed in such a way as to alter a physical, chemical, or thermodynamic property of the granular material; a means for the inflow 20 of granular material into the processing chamber 30; and a means for outflow 50 of the granular material from the processing chamber 30. The descriptions of the various embodiments herein are intended to be exemplary of some forms in which the present invention may be embodied, and should not be construed as limiting in any way as to the whole scope of the claimed invention.

The processing chamber 30 may be embodied in a multitude of different configurations and serve a variety of different purposes. The main feature across all embodiments is that the processing chamber 30 is able to process a granular material continuously under a contained atmosphere, which is an improvement over batch reaction systems and batch processing systems or discontinuous throughput systems.

The contained atmosphere in the various embodiments may be such that it has a different total pressure when compared to the ambient pressure outside the processing chamber 30. This allows for processing of granular material at both a higher pressure and also at a lower pressure, or even a vacuum, relative to the external environment. In other embodiments the processing chamber 30 may contain an atmosphere with partial pressure differences in which the relative concentration of a certain gas or gasses is elevated or lowered as compared to the other gasses present and the concentration of those gasses within the atmosphere outside of the processing chamber 30.

In most embodiments the processing chamber 30 will be fitted with inlet and outlet valves, ports and other forms of connections for introducing into the processing chamber 30 other elements, compounds, or components necessary or desired for the process taking place within the processing chamber 30, or for removing products of the process taking place. These connections may also be used to control the various atmospheric parameters within the processing chamber 30, such as temperature, pressure and molecular composition of the atmosphere. The processing chamber 30 may also have inputs for power supply to mechanisms or devices in the processing chamber and electronic communication with sensors or electronics in the processing chamber. The processing chamber 30 may also have optical connections to the external exterior of the processing chamber, such as for fiber optic, signals, optical power input, or a viewing window. In other embodiments, the processing chamber 30 may have a mechanical or manual connection to the exterior environment, such as a mechanical arm or a glovebox-type configuration for manipulating objects within the processing chamber 30.

The connections to the processing chamber 30 for the inflow 20 and outflow 50 of the granular material are the main components of the invention described herein. These valves allow for the continuous throughput of a granular material without the loss of the atmosphere within the processing chamber 30. To achieve this, the means for substantially continuous inflow 20 and outflow 50 of granular material manipulate the disposition of the granular material in relation to the vapor permeability of the bulk granular material, the path length for escape of a gas molecule from the processing chamber 30, the cross-sectional area of the openings and the pathway through which the granular material must pass, the packing density of the granular material, the grain size distribution of the granular material, the moisture content of the granular material, and other variables as they relate to the physical disposition of the granular material.

In most embodiments, the means for substantially continuous inflow 20 of granular material will be located at the base of a hopper 10 or similarly situated container for creating an overburden of the granular material to feed it into the means for substantially continuous inflow 20. Said means for substantially continuous inflow 20 may take a variety of forms, but all of these forms move the granular material from the bottom of the overburden into the processing chamber 30 while keeping the density of the grain-packing of the granular material high, the vapor permeability low, and the molecular path length for a gas molecule through the mechanism long enough to keep the atmosphere within the processing chamber 30 substantially sealed from the external environment. In the simplest form, the means for substantially continuous inflow 20 is a embodied by one or more slits, holes or similar gaps between the base of the hopper 10 and a wall of the processing chamber 30 with a vibratory mechanism to help the granular material succumb to gravity and fall through the openings into the processing chamber 30. In other embodiments, the means for substantially continuous inflow 20 may be a rotating drum located in an opening between the hopper 10 and the processing chamber 30, with openings in the drum to collect the granular material, rotate around, and then deposit the material into the chamber in a substantially continuous manner. In other forms, the drum may be replaced by a cog, a paddlewheel, gear or similarly situated mechanism to rotate and move the granular material from one volume to the next.

The preferred embodiments envisioned by the inventors involve the use of an auger 60 to convey the granular material from the hopper 10 into the processing chamber 30. The auger 60 may be situated within a cylindrical enclosure or pipe extending from the base of the hopper 10 into the processing chamber 30, such that the processing chamber 30, the pipe, and the hopper 10 constitute a substantially sealed system with the only openings existing at the top of the hopper 10 and the means for substantially continuous outflow 50 at the other end of the processing chamber 30. This embodiment allows the auger 60 to move the granular material continuously into the processing chamber 30 while simultaneously increasing the molecular path length for gas molecules to leave the system. In some embodiments, the flights of the auger 60 may vary in the spacing and/or angles between them, such that they are spaces closer together 70 within the enclosure than at the connection to the bottom of the hopper 10 where the granular material enters the auger 60 enclosure. This way of spacing the flights will create a higher packing density of the granular material within the enclosure along the length of the auger 60, thus lowering the gaseous permeability of the granular material.

The means for substantially continuous outflow 50 of granular material from the processing chamber 30 after it has been processed include all of the means for substantially continuous inflow 20 into the processing chamber 30, but reversed, such that they are moving the processed granular material from an internally formed hopper 40 within the processing chamber 30 to the exterior environment outside of the processing chamber 30. Once again, as with the means for substantially continuous inflow 20, the preferred embodiments for the means for substantially continuous outflow 50 involve the use of an auger 60 extending from the base of the internally formed hopper 40 to the exterior environment outside of the hopper 40. This auger 60 may also include flights that have varied spacing such that they are closer together 70 within the enclosure than at the bottom of the internal hopper 40 where the granular material enters the outflow auger 60.

The various embodiments may also involve the use of a multiple chamber and/or hopper system to further ensure containment of the atmosphere within the processing chamber 30, or prevention of external atmosphere from entering the processing chamber 30. These multiple chambers and/or hoppers may contain a series of vacuum pumps or similar devices to ensure no contamination reaches the chamber 30 or no part of the atmosphere within the chamber 30 leaves the processing chamber 30 system.

In some embodiments, the grain size distribution of the granular material may be larger than required for creating an optimally low gaseous permeability. In these embodiments, if there exists a portion of the granular material that is sufficiently fine-grained, then that portion may be separated from the larger grains after going through the processing chamber 30 by sieving or similar methods of granular separation, then recirculated back to the inflow hopper 10 for lowering the average grain size to optimize the gaseous permeability of the inflowing granular material. This recirculation may be achieved by any means for transporting a fine-grained material 100, including, but not limited to, belt conveyors, auger conveyors, bucket conveyors, pneumatics, or similarly situated devices. In embodiments where a sufficiently fine-grained fraction of the granular material doesn't exist, a fine-grained material may be introduced into the system and recirculated for the purpose of maintaining an optimally low gaseous permeability within the system. The specific fine-grained material introduced may vary from one embodiment to the next, as it must be inert relative to the process taking place within the processing chamber 30.

One embodiment of the invention is for the specific purpose of carbonating recycled concrete aggregate. In this embodiment, the fine-grained material is generally going to be crushed concrete from an extant concrete structure, which can be carbonated under a carbon dioxide atmosphere to act as a carbon dioxide sink and to increase the strength of the recycled concrete for use as aggregate in new concrete structures. In this embodiment, the processing chamber 30 will likely have an elevated partial pressure of carbon dioxide and a method of introducing the carbon dioxide into the processing chamber 190, such as a pump from a storage tank of gaseous or liquid carbon dioxide 200, though many other possible methods of achieving this are potential aspects of this embodiment. The processing chamber 30 will also have a means for conveyance of the granular material to move it from the means for inflow 20 to the means for outflow 40. This means for conveyance must ensure the recycled concrete aggregate has sufficient residence time within the chamber 30 to carbonate, as determined by the carbon dioxide concentration, temperature and pressure. The means for conveyance envisioned include, are not limited to: a belt conveyor; a bucket conveyor; a large screw-type auger or series of smaller parallel augers; a fluidized bed that is either slightly sloped from the means for inflow to the means for outflow or has a the airflow introduced for fluidization of the granular material a directed at a slight angle towards the means for outflow; a series of slides or ledges across which the concrete aggregate is conveyed; one or more combs, plows or scrapers to push the concrete aggregate through the chamber 30; and any similarly situated devices.

Another embodiment of the invention described herein is for the processing of volatile-containing regolith or soil from a planetary body, moon, asteroid, comet or similar object. The first step in this process is the delivery of excavated and partially or wholly disaggregated volatile-containing regolith to the processing system, whereby it is deposited into a vibratory sieve 180 or other device for the sorting of particles by size. The size of particles sieved for further processing will be determined by various factors relating to the operating parameters required by the intended use, pressurization needs, volume of regolith to be processed per unit time, and other factors. In some embodiments, wherein the excavated regolith is poorly disaggregated, a crushing, grinding, or other disaggregation method may be used prior to sieving. Upon passing through the sieve 180, the regolith enters a hopper 10 of dimensions and geometry designed with the intended use and challenges of operation in the specific planetary environment in mind, such as angularly faceted sides and a vibratory mechanism (or incorporation with the vibratory mechanism of the sieve 180) to ensure there is no clogging, bottlenecking, or hanging up in a potentially lower gravity environment as compared with that of Earth. The dimensions of the hopper 10 shall also be such that they ensure the requisite over burden needs are met for pressurization requirements. The hopper 10 shall be designed to deliver the regolith to the means for substantially continuous inflow 20 at the base of the hopper 10.

The specific dimensions, unique component parts or design features, materials of construction, drive motors, computer interfacing, and other aspects of each of the various embodiments of the processing system are to be determined by the specific pressures, delivery rates, temperatures, and other operating parameters of the intended use of the processing plant (e.g., water collection, volatile collection, additive manufacturing, carbothermal reduction, molten electrolysis, etc.).

Once regolith has entered the processing chamber 30, one or more of the following processes will be implemented to release the volatiles from the regolith. The first embodiment of the process for releasing volatiles delivers regolith into the processing chamber 30, depositing it onto a conveyor belt 140. The conveyor belt 140 moves the regolith along through the chamber 30, passing under a hood or comb 120 that will smooth and contour the regolith into an optimal topology on the conveyor belt 140 for the transport of vapor out of the regolith, improve thorough heat transfer throughout the regolith, and help mitigate dust production in the processing chamber 30.

After being contoured by the comb 120, the regolith is heated by a means for heating. The means for heating may be conductive heating elements contacting the regolith directly, radiative heating, ultrasonic heating, direct solar or visible light heating, infrared heating, or radiation from other electromagnetic energy sources.

In one embodiment, the regolith passes under a focused microwave emitter 130 to release the volatiles contained within the regolith. The microwave emitters 130 may be used in conjunction with other heat sources to improve efficiency and ensure melting, such as radiative heaters, infrared heaters, direct conductance, ultrasonic or other means. The frequency or frequencies of the microwaves emitted 130 by the emitter are optimized for the heating of water and other volatiles without losing energy to the incidental heating of regolith. The efficiency of the microwave emitter 130 is also further enhanced by the positioning of a series of microwave-reflective surfaces 150, such as Gobel mirrors, parabolic reflectors, or other such reflectors, intended to redirect any microwaves passing through the regolith on the belt back and forth across the belt 140 to increase the amount of emitted microwave radiation absorbed by the volatiles. In some embodiments, the processing chamber 30 may contain more than one comb 120 and means for heating in a series to ensure full release of volatiles from the regolith into the vapor phase. In embodiments containing more than one comb 120, the teeth of the comb may be positioned at an offset from those of the preceding comb 120 in the series, thus shifting, flipping, or mixing the regolith to facilitate improved transport of any volatiles contained therein when vaporized.

After the volatiles have been released from the regolith as vapor, they are removed from the processing chamber by a means for removal of a phase-changed volatile substance 160. This means for removal may be a mechanical mechanism, such as a pump or fan of any type, but it may also be a passive mechanism such as a cold trap into which the volatiles flow and are condensed for storage and later collection. The inventors envision the possibilty to us any mechanism or method designed to move vapor from one volume to another to accomplish the collection of volatiles released from the regolith. Once the vapor is removed from the processing chamber 30, it is condensed into a storage container 210 by one or more of several condensation methods. In most embodiments, the connection 170 between the processing chamber and the condensation unit/storage tank is designed with a specific geometry and path length to mitigate the transport of dust from the chamber into the condensing mechanism and storage tank. In some embodiments, an active or passive filtration system may be used to capture dust from the vapor before condensation.

Once the regolith has passed through the microwave emitters 130 and the volatiles have been released, the regolith is removed from the processing chamber in a way that is designed to mitigate the creation of dust and allow for the creation of a regolith plug to seal the processing chamber from the external environment. In one embodiment of the design, the regolith slides gently from the conveyor 140 onto a convex planar surface that feeds it into the means for substantially continuous outflow to be expelled from the chamber. In another embodiment, the regolith is fed from the conveyor 140 into a hopper 40 or series of hoppers that facilitate the transfer of regolith out of the processing chamber and creation and maintenance of a pressure gradient through the low permeability regolith overburden in the hopper or hoppers. In another embodiment, the regolith is removed from the conveyor belt by a paddle wheel, bucket drum, or similarly situated mechanism, which is positioned and tightly fit into a wall, divider, or entryway that leads to an exit hopper, chute, or other apparatus to remove the regolith from the system while mitigating the creation and transport of dust into the chamber.

In some embodiments, the system may contain mechanisms for self-cleaning, such as brushes, pneumatics, vibratory, ultrasonic, or other mechanisms. In another embodiment, it may contain access panels for manual or automatic cleaning.

In some embodiments, the processing chamber 30 and/or other parts of the system may contain heaters to prevent the deposition or accumulation of volatiles in undesired locations after being released from the regolith, but before containment in the storage container. The heaters may be radiative, conductive, vibratory (e.g. ultrasonic), or otherwise, and they may be positioned at one or more locations throughout the system, as determined by functional needs.

The device, in all the various embodiments, may contain one or more computers, processors, or similar devices, connected to or otherwise interfaced with a network of sensors and other instruments for monitoring operational conditions of the device, along with any and all motors, valves, heaters, emitters, pumps, and other mechanisms for the operation of the device. The goal of this system will be to monitor and optimize operating parameters to ensure the desired performance and production or output is being achieved, along with determining if there are system failures or other issues of any kind. The computer system or processing system may also be connected to an external network via an antenna or similar device.

In some embodiments the entire system as described may be a stationary system, but in other embodiments it may be contained on a mobile platform. The mobile platform, commonly referred to as a rover, would be designed so as to allow the processing plant to move into locations where the volatile-containing regolith is being excavated This would help to minimize the energy used to transport excavated material by requiring only the transport of volatiles in storage tanks.

In some embodiments the mobile processing plant may move from one volatile rich region to the next with a contingent of other rovers for excavation, storage of volatiles, energy/power systems, or power supply, transport of material, and/or other various specialized tasks. some embodiments these rovers may assemble together in an interlocking method to create a larger, singular unit for transit from one location to another. This singular unit may locomote by using the wheels and drive mechanisms of one or more of the individual rovers in some embodiments, but in other embodiments it may travel between locations using bipedal locomotion.

What is claimed:

1. A device for the continuous processing of granular material under an atmosphere, comprising:
A chamber in which a granular material is processed in a way that alters a property of said granular material selected from the group consisting of: thermodynamic, chemical, physical; and
said granular material is deposited into said chamber by means for substantially continuous inflow of granular material; and
said granular material is removed from said chamber after processing by means for substantially continuous outflow of a granular material; and
wherein said means for the substantially continuous inflow and said means of substantially continuous outflow create a substantially sealed atmosphere within said chamber.

2. The device as recited in claim 1 wherein a hopper is situated above a portion of the chamber such that said hopper has a bottommost section intersecting with a wall of said chamber, wherein said intersection defines an opening between said hopper and said chamber to for a continuous volume defined by the inside of said hopper and the inside of said chamber; and
wherein the means for substantially continuous inflow of the granular material into said processing chamber is located within the opening defined by the intersection of said hopper and said chamber.

3. The device as recited in claim 1 wherein the means for substantially continuous inflow of the granular material is an auger extending from the bottommost section of a hopper, through a cylindrical enclosure connecting the hopper to the processing chamber, then into the interior of the processing chamber such that said auger is able to continuously transport the granular material from the hopper to the processing chamber; and
Said auger is driven by a motor connected to an energy source.

4. The device as recited in claim 1 wherein a product of the process taking place within the processing chamber is a processed granular material; and
said processing chamber has an internal structure such that a section of the internal structure forms an internal hopper for the collection of the processed granular material prior to outflow from the processing chamber; and
said internal hopper has a bottommost section defining an opening between the inside of the processing chamber and the exterior of the processing chamber; and
the means for substantially continuous outflow of a processed granular material is situated within said opening.

5. The device as recited in claim 4 wherein the means for substantially continuous outflow of a granular material is an auger extending from the bottommost section of the internal hopper through a cylindrical enclosure to the exterior of the processing chamber.

6. The device as recited in claim 3 wherein the auger has flights set at a varied pitch along the length of said auger, such that at least two flights of the auger are spaced closer together at a point within the cylindrical enclosure than the flights are spaced at the end of the auger extending from the cylindrical enclosure into the bottommost section of the hopper, thus creating a section within the cylindrical enclosure in which the granular material is compressed to a higher density to reduce the vapor permeability of the granular material.

7. The device as recited in claim 5 wherein the auger has flights set at a varied pitch along the length of said auger, such that at least two flights of the auger are spaced closer together at a point within the cylindrical enclosure than the flights are spaced at the end of the auger extending from the cylindrical enclosure into the bottommost section of the internal hopper, thus creating a section within the cylindrical enclosure in which the processed granular material is compressed to a higher density to reduce the vapor permeability of the processed granular material.

8. The device as recited in claim 1 wherein the granular material has a grain size distribution such that a portion of the granular material is fine-grained, having a grain size less than 62.5 μm; and
the means for substantially continuous outflow directs the outflowing processed granular material, including the fine-grained portion, across a sieve, such that the fine-grained passes through the sieve, but the processed granular material having a larger grain size does not pass through the sieve; and
after passing through the sieve, the fine-grained material is returned to the means for substantially continuous inflow of a granular material by means for transporting fine-grained material, ensuring that the grain size distribution of the granular material entering the means for substantially continuous inflow is always optimized for creating low vapor permeability.

9. The device as recited in claim 1 wherein the granular material is from a planetary body and contains a volatile compound; and
said granular material containing a volatile compound enters the processing chamber by the means for substantially continuous inflow, which deposits the granular material containing a volatile compound onto means for conveyance to move the granular material containing a volatile compound through the processing chamber; and
said means for conveyance passes said granular material containing a volatile compound under a hood surrounding the end of the means for substantially continuous inflow that is depositing the granular material containing a volatile compound into the processing chamber, such that said hood substantially encloses said means for conveyance, with said hood only having an opening through which to pass the granular material containing a volatile compound defined by a cross-sectional area perpendicular to the direction of conveyance along said means for conveyance, extending horizontally the width of said means for conveyance and vertically from the surface of said means of conveyance to a height of between 2 millimeters and 5 centimeters; and
said chamber contains means for heating said granular material containing a volatile compound to induce a phase change of said volatile compound; and
said chamber is connected to means for removal of a phase-changed volatile compound for the collection of said volatile compound from the processing chamber; and
said means for conveyance moves the processed granular material to means for substantially continuous outflow of a processed granular material.

10. The device as recited in claim 1 wherein the granular material is crushed concrete particles, which are moved through the processing chamber, from the means for substantially continuous inflow to the means for substantially continuous outflow by means for conveyance; and
the processing chamber is connected to a means for creating a carbon dioxide atmosphere, such that the atmosphere within the processing chamber has a carbon dioxide partial pressure of at least 1013 Pa (0.01 atm) to cause carbonation of the concrete particles.

11. A method for the continuous processing of granular material under an atmosphere comprising the steps of:
depositing the granular material into a processing chamber by means for substantially continuous inflow; and
processing the granular material inside the chamber so as to alter a property of said granular material, with said property selected from the group consisting of:
physical, chemical, and thermodynamic; and
removing processed granular material from the chamber by means for substantially continuous outflow; and
maintaining a substantially sealed atmosphere within the processing chamber through the means for substantially continuous inflow and the means for substantially continuous outflow.

12. The method as recited in claim 11 further comprising using a hopper to contain the granular material prior to entering the chamber, with said hopper connected to an upper portion of the wall of the processing chamber and depositing the granular material into the processing chamber by a means for substantially continuous inflow located within an opening between the bottom of the hopper and the wall of the processing chamber.

13. The method as recited in claim 11 further comprising using an auger as the means for substantially continuous inflow, with said auger extending from the bottommost section of a hopper, through a cylindrical enclosure connecting the hopper to the processing chamber, then into the interior of the processing chamber such that said auger is able to continuously transport the granular material from the hopper to the processing chamber.

14. The method as recited in claim 11 further comprising processing the granular material to create a processed granular material; and
providing an internal hopper within the interior of the processing chamber for collecting the processed granular material prior to discharging it from the processing chamber by the means for substantially continuous outflow; and
locating the means for substantially continuous outflow at an opening defined by the bottommost section of the internal hopper and communicating with the external environment, such that the means for substantially continuous outflow removes the processed granular material from the processing chamber.

15. The method as recited in claim 14 further comprising using an auger extending from the bottommost section of the internal hopper through a cylindrical enclosure to the exterior of the processing chamber as the means for substantially continuous outflow.

16. The method as recited in claim 13 further comprising varying the pitch and spacing of the flights of said auger, such that at least two flights of the auger are spaced closer together at a point within the cylindrical enclosure than the flights are spaced at the end of the auger extending from the cylindrical enclosure into the bottommost section of the hopper, thus creating a section within the cylindrical enclosure in which the granular material is compressed to a higher density to reduce the vapor permeability of the granular material.

17. The method as recited in claim 15 further comprising varying the pitch and spacing of the flights of said auger, such that at least two flights of the auger are spaced closer together at a point within the cylindrical enclosure than the flights are spaced at the end of the auger extending from the cylindrical enclosure into the bottommost section of the internal hopper, thus creating a section within the cylindrical enclosure in which the processed granular material is compressed to a higher density to reduce the vapor permeability of the processed granular material.

18. The method as recited in claim 11 further comprising ensuring that the granular material entering the processing chamber has a grain size distribution such that a portion of the granular material is fine-grained, having a grain size less than 62.5 μm; and
directing the outflowing processed granular material, including the fine-grained portion, across a sieve, such that the fine-grained passes through the sieve, but the processed granular material having a larger grain size does not pass through the sieve; and
returning the seived fine-grained material to the means for substantially continuous inflow of a granular material by means for transporting fine-grained material, ensuring that the grain size distribution of the granular material entering the means for substantially continuous inflow is always optimized for creating low vapor permeability.

19. The method as recited in claim 11 further comprising providing volatile containing granular material from a planetary body as the granular material to be processed; and
using the means for substantially continuous inflow to deposit the granular material containing a volatile compound into the processing chamber and onto means for conveyance to move the granular material containing a volatile compound through the processing chamber; and
passing said granular material containing a volatile compound under a hood surrounding the end of the means for substantially continuous inflow that is depositing the granular material containing a volatile compound into the processing chamber, such that said hood substantially encloses said means for conveyance, with said hood only having an opening through which to pass the granular material containing a volatile compound defined by a cross-sectional area perpendicular to the direction of conveyance along said means for conveyance, extending horizontally the width of said means for conveyance and vertically from the surface of said means of conveyance to a height of between 2 millimeters and 5 centimeters; and
using a means for heating said granular material containing a volatile compound to induce a phase change of said volatile compound; and
removing said volatile compound from the processing chamber by means for removal of a phase-changed volatile compound to the collect of said volatile compound from the processing chamber; and
using the means for conveyance to move the processed granular material to the means for substantially continuous outflow of a processed granular material.

20. The method as recited in claim 11 further comprising providing crushed concrete particles as the granular material to be processed and moving the crushed concrete particles through the processing chamber, from the means for substantially continuous inflow to the means for substantially continuous outflow by means for conveyance; and
connecting the processing chamber to a means for creating a carbon dioxide atmosphere, such that the atmosphere within the processing chamber has a carbon dioxide partial pressure of at least 1013 Pa (0.01 atm) to cause carbonation of the concrete particles.
